(19) United States
(12) Patent Application Publication
(10) Pub. No.: US 2002/0092974 A1
(43) Pub. Date: Jul. 18, 2002

(54) Gas sensor based on energy absorption

(76) Inventor: Andrian I. Kouznetsov, Santa Barbara, CA (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/760,330

(22) Filed: Jan. 12, 2001

(51) Int. Cl. G01V 8/00

(52) U.S. Cl. 250/222.2

(57) ABSTRACT

A gas sensor (10) exposed by diffusion to a gas flow and operable to measure the presence of a particular gas component of the gas flow. The sensor (10) comprises a base (20), a diffuser (34), a radiant energy source (36), a radiant energy detector (38), and a detection chamber (40). The base (20) is a printed circuit board (PCB) to which the source (36), detector (38), and other electronics are mounted. The diffuser (34) is interposed between the gas flow and the detection chamber (40). Thus, rather than directly exposing the source (36), detector (38), and other electronics to the full force of the gas flow, the gas is passed to and from the detection chamber (40) by diffusion. The diffuser (34) comprises a filter (35), an air gap (44), and plurality of diffusion holes (46). The filter (35) is further operable to remove harmful materials, such as volatile organic compounds (VOCs), from the gas prior to measurement. The source (36) and detector (38) are located within the detection chamber (40). The source (36) radiates energy having a particular characteristic such that the energy is proportionally absorbed by the gas component. The detector (38) measures the presence of any unabsorbed energy and generates an output signal indicative thereof. The difference between the amount of detected energy and a pre-established reference value indicates the amount of the particular gas component present in the gas flow. The detection chamber (40) is coated with a material known to reflect the radiated energy.

### BACKGROUND OF THE INVENTION

1. Field of the Invention

The present invention relates to gas sensing devices. More particularly, the invention relates to devices using radiated energy and properties of energy absorption to detect and measure the presences of various gases.

2. Description of the Prior Art

It is often desirable to detect and measure the presences of various gases. This is true, for example, in manufacturing, diagnostic, and safety applications, where the presence of a particular gas or a particular concentration of gas can affect product or process quality, reveal faulty equipment operation, or endanger the health and safety of an occupant or operator.

Various problems can arise when attempting to measure component gases of a gas sample under certain conditions. These problems include, for example, humidity, which can cause erroneous measurements and damaging condensation inside the sensor; high concentrations of interfering gases, which can lead to cross-interference problems when measuring gases of interest; the presence of damaging particles or volatile organic compounds (VOCs); and high temperatures associated with the gases to be measured, which can damage sensitive sensor components. Although various complex and expensive solutions to these problems may exist, many applications are cost sensitive and require correspondingly low cost solutions.

Furthermore, existing gas sensors are typically designed so that the gas of interest flows directly through the sensor assembly. This can substantially reduce the useable life of sensitive sensor components, such as filters, and make protecting, monitoring, and servicing the sensor difficult, particularly if the process producing the gas flow is not stopped or the gas re-routed while doing so.

Mitigating some or all of these problems without resorting to complex and expensive components or techniques has so far eluded the art.

### SUMMARY OF THE INVENTION

The present invention solves the above-described problems and provides a distinct advance in the art of gas sensing devices. More particularly, the present invention provides a gas sensor operable to accurately, efficiently, and reliably sense the presence and concentration of a particular gas component of a gas flow. This is accomplished without resort to pumps other expensive, complex, maintenance intensive, or failure prone components or techniques.

The preferred gas sensor operates under the principle of infrared absorption, which states that a gas will proportionally absorb infrared radiation or other radiant energy having particular characteristics, such as a particular wavelength or range of wavelengths. Thus, by exposing the gas sample to infrared energy having the appropriate characteristics with regard to the gas component of interest, and measuring the amount of unabsorbed radiation, the amount of the particular gas component can be determined as being proportional to the difference between the amount of sourced radiation and the amount of detected radiation. In a preferred form, the detector's measurement is compared to a predetermined reference value, with the reference value being established under known conditions, such as the absence of the gas of interest.

The preferred sensor comprises a base, a diffuser, an infrared source, an infrared detector, and a detection chamber. The base is preferably a printed circuit board (PCB) to which the source, detector, and other electronics are mounted. The diffuser is located between the gas flowpath and the detection chamber so that, rather than exposing sensitive sensor components to the full force and flow of the gas, the gas is allowed to diffuse into the detection chamber. The diffuser comprises a filter, an air gap, and plurality of diffusion holes. The filter is further operable to remove harmful materials, such as VOCs, dust particles, or moisture, from the sample prior to measurement. The source and detector are located within the detection chamber, which is coated with a material known to reflect infrared radiation, preferably gold, in order to facilitate detection.

The preferred sensor provides numerous advantageous low cost features and techniques for overcoming problems currently present in the art. For example, the sensor is preferably not located so as to be expose the sensitive sensing components to the direct flow of the gas to be measured; rather, the gas is introduced into the sensor by diffusion via the diffuser. This provides at least three advantages: First, it results in longer filter life as the filter need not contend with the full flow and force of the gas, which means that the filter experiences less physical stress and is exposed to fewer filter clogging materials. Second, the gas, which may be 700° to 800° F. in the flowpath, is allowed time to cool as it diffuses, thereby adding to the longevity of the sensing components and measuring electronics. Third, locating the sensor outside of the primary flowpath allows for easier access to and servicing of the sensor without interfering with the process producing the gas.

These and other novel features of the present invention are more fully described below in the section entitled A DETAILED DESCRIPTION OF A PREFERRED EMBODIMENT.

### BRIEF DESCRIPTION OF THE DRAWING FIGURES

A preferred embodiment of the present invention is described in detail below with reference to the attached drawing figures, wherein:

FIG. 1 is a plan view showing correct placement of a gas sensor along a gas duct, the gas sensor corresponding to a preferred embodiment of the present invention;

FIG. 2 is a side sectional view of a gas sensor corresponding to a preferred embodiment of the present invention; and

FIG. 3 is a top sectional view of a gas sensor corresponding to a preferred embodiment of the present invention.

### DETAILED DESCRIPTION OF A PREFERRED EMBODIMENT

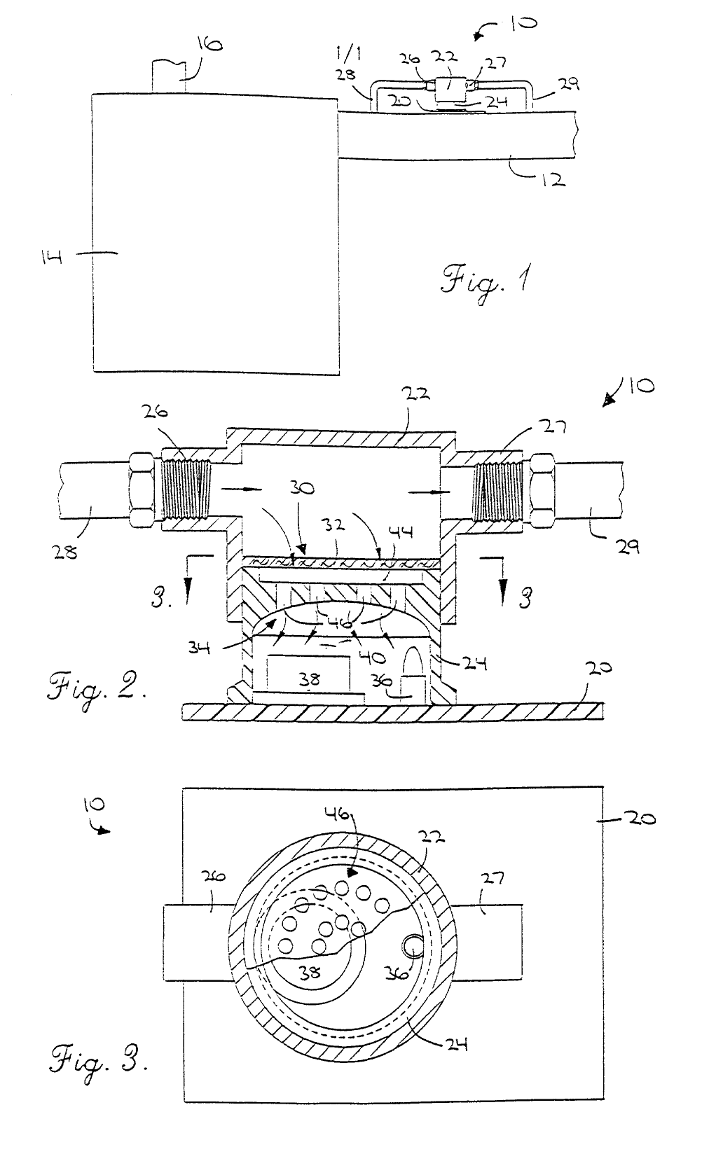

Referring to FIG. 1, a gas sensor 10, corresponding to a preferred embodiment of the present invention, and operable to detect and measure gas presences, is shown mounted upon an exhaust flue or duct 12 coupled with a combustion chamber 14. The combustion chamber 14, which, for example, may be part of a furnace or oven, is also shown coupled with an intake duct 16. The sensor 10 has application in many different gas sensing contexts and is shown sensing exhaust gases for illustration only. Contemplated applications include, for example, process control, such as monitoring oven cleaning cycles or dryer cycles, and hazard warning.

Furthermore, though shown as depending from a secondary flowpath 28,29, the sensor may be configured so as to depend instead from the primary flowpath 12. The importance is not from which flowpath the sensor depends, but merely that sensitive sensor components not be exposed to the direct full force and flow of the gas. Thus, while FIG. 1 shows a particular embodiment suitable for a particular application, FIG. 2 shows the preferred relationship between the sensor and the flowpath, regardless of whether the flowpath is primary or secondary, wherein gas is introduced to the sensor by diffusion rather than direct exposure to the flow.

The preferred sensor embodiment 10 broadly comprises a base 20; a cover22; and a sensor housing 24. The base 20 provides a structure by which the sensor 10 may be mounted to the exhaust duct 12 or other surface. The base 20 may be any practical shape conforming to the surface upon which it is to be mounted, including flat or curved. Preferably, screws or bolts are used to securely attach the sensor 10 to the mounting surface, though any practical attachment means may be used. In one preferred embodiment, the base 20 is a printed circuit board (PCB) performing the dual role of operably mounting various electronic components associated with the sensor 10 and supportively coupling the sensor 10 to the mounting surface 12. In this latter embodiment, the base/PCB 20 is provided with reinforced, insulating eyelet holes for allowing mounting screws or bolts to safely pass through the base/PCB 20.

Referring to FIGS. 2 and 3, the cover 22 directs the gas flow and protects internal sensor components, described below. The cover 22 includes first and second connection fittings 26,27 operable to threadably couple the cover 22 with inlet and outlet pipes 28,29. The inlet 28 is connected at a first end to the duct 12 upstream of the sensor 10, and is operable to direct a portion of the gas flowing through the duct 12. The inlet pipe 28 is threadably coupled at a second end by the first fitting 26 with the cover 22, thereby directing the flow of gas into the cover 22. The outlet pipe 29 is threadably coupled at a first end by the second fitting 27 with the cover 22, thereby directing the flow of gas out of the cover 22. The outlet 29 is connected at a second end to the duct 12 downstream of the sensor 10, and is operable to return the gas to the duct 12. The cover 22 is preferably removably attached to the sensor housing 24 to allow for simpler sensor assembly and easier maintenance.

The sensor housing 24 houses and protects a diffuser 34, including a filter 35; a radiant energy source 36; a radiant energy detector 38; and a detection chamber 40. As discussed above, a primary point of novelty of the present invention is that the sensing components are exposed to the gas by diffusion. Thus, the sensor housing 24 should depend or otherwise branch from the primary 12 or secondary flowpath 28,29. In the illustrated embodiment, the sensor housing 24 is coupled with the cover 22 so as to depend from the secondary flowpath 28,29, thereby forming a closed-ended branch thereof.

The preferred diffuser 34 comprises the filter 35, an air pocket 44, and a plurality of diffusion holes 46, which operate together to diffuse the gas into and out of the detection chamber 40. The filter 35 is further operable to remove undesired material, particulates, or substances, such as smoke, oil, dust, and moisture, from the gas to protect other components and prevent erroneous measurements due to a build up of obstructing material in the sensor housing 24 or on the components themselves. The filter 35 may contain an activated carbon layer to absorb the excess moisture and aggressive gases and to prevent condensation. Because the filter 35 is oriented such that the gas flow moves along but not across it, significantly fewer contaminants become trapped within the filter 35, thereby extending its usable life. A suitable filter, for example, is a round, 0.5 inch diameter polytetraflourethylene (PTFE) filter available from Donaldson Company Inc. Alternatively or additionally, other filters may be used depending on the nature of the material to be removed from the gas sample.

The filter 35 is located on the flowpath side of the pocket 44, which allows for use of a filter having a relatively large surface area. The larger surface area facilitates adequate diffusion rates for achieving a suitable sensor response time. Once the gas molecules have diffused through the filter 35 and into the pocket 44, they enter the chamber 40 via the diffusion holes 46, which are of a small enough diameter so as not to interfere with the reflective properties of the coated chamber 40, described below. Other diffusion devices or methods may be used where practical and desirable.

The radiant energy source 36 is preferably an electric lamp operable to produce broadband IR radiation in response to an input electrical signal. A suitable lamp is available, for example, from Gillway Technical Lamps. The wavelengths or other characteristics of the radiant energy produced by the source 36 will vary depending on the gas to be detected or measured.

The radiant energy detector 38 detects a particular wavelength or range of wavelengths of the broadband IR radiation produced by the radiant energy source 36 and is further operable to generate an output electrical signal corresponding to the strength of the detected IR radiation. The strength of this output signal is compared to a reference value to determine the presence and concentration of gas in the sensor housing 24, with the signal strength difference resulting from radiation being absorbed by the gas. A suitable detector 38 is available, for example, from the Perkin-Elmer Corp.

The reference value represents the detected signal strength under known conditions, such as the absence of the gas of interest, and may be established during manufacturing when suitable gas measurements may be made under controlled conditions. Alternatively or additionally, the sensor 10 may periodically confirm the reference value by making self-calibration measurements when the gas-producing process is inactive.

As desired, more than one detector 38 may be incorporated into the sensor 10, with each such detector 38 being operable to detect a different wavelength or range of wavelengths of unabsorbed radiation and thereby measure the presence of a different gas of interest. Alternatively, it may be desirable to use a multi-channel detector package. As will be appreciated by those with ordinary skill in the art, the plurality of detectors can be identical to each other except for an interference filter placed over each detector to define the range of wavelengths the detector can be exposed to.

The detection chamber 40 facilitates measurements and substantially encloses and seals the source 36 and detector 38 against the ambient environment. The surface of the plastic chamber 40 is preferably coated with gold or other IR reflective material operable to reflect, rather than absorb, the IR radiation produced by the source 36. The chamber surface thus acts to direct the IR radiation from the source 36 to the detector 38. If the chamber surface were IR absorptive, insufficient IR radiation would reach the detector 38, thereby making absorption measurements more difficult. Just as the characteristics of the radiation produced by the source 36 will need to change depending on the particular gas to be detected, the reflective properties of the coating must correspondingly depend upon the characteristics of the radiation produced by the source 36. Furthermore, it may be desirable that the coating be reflective only in a specific spectral band or range of wavelengths to provide increased spectral sensitivity or to replace the IR filter typically used to select the appropriate spectral band.

In embodiments where the source 36 and detector 38 are mounted directly to the base 20 and the detection chamber 40 placed thereover, the surface of the portion of the base 20 on which the components are mounted should be coated with the IR reflective coating as well.

The chamber 40 is preferably of a shape, such as a domed cylinder, operable to direct sourced radiation to the detector 38. However, the chamber's shape can affect or enhance the sensor's ability to detect low concentrations of certain gases. Thus, for example, in order to detect low concentrations of CO gas, a longer distance is required between the source 36 and the detector 38, resulting in a relatively elongated chamber 40.

In operation, gases are produced in the combustion chamber 14 and released through the exhaust duct 12 (See FIG. 1). A portion of the exhausting gas flows into the sensor inlet pipe 28 and into the sensor cover 22. A first portion of the gas entering the cover 22 will immediately exit via the outlet pipe 29 and rejoin downstream the gas flowing in the duct 12. A second portion of the gas entering the cover 22 will diffuse through the filter 35 and into the chamber 40. Within a relatively short period of time, approximately five minutes for the preferred embodiment, the concentration of gases in the chamber 40 will be sufficiently similar to the concentration of gases in the gas flow to make accurate measurements.

The source 36 produces broadband IR radiation which is reflected by the surfaces of detection chamber and absorbed by the gas to a degree proportional to the amount of gas present. Because the detection chamber is coated with IR reflective material, very little IR radiation is absorbed by its surfaces. A range of wavelengths of the broadband IR radiation not absorbed by the gas or surfaces, or lost through the diffusion holes 46, is detected by the detector 38. The detector 38 is operable to generate an electrical signal corresponding to the strength of the detected IR radiation. This signal is sent to electronics operable to determine, based upon a difference between a pre-established reference value and the amount of detected IR radiation, the amount of gas present in the reflective chamber. This sample is considered indicative of the amount of the particular gas present in the combustion gas produced in the combustion chamber 14 and flowing in the exhaust duct 12.

Although the invention has been described with reference to the preferred embodiment illustrated in the attached drawing figures, it is noted that equivalents may be employed and substitutions made herein without departing from the scope of the invention as recited in the claims. In particular, the present invention is for a gas sensor independent of any particular application or gas. That is, the sensor 10 may be adapted to detect and measure any gas by changing the wavelength of the radiant energy emitted by the source 36, providing a corresponding reflective coating and detector 38, and possibly manipulating the size or shape of the chamber 40. The electronics or algorithms used to interpret the signal produced by the detector 38 may need to be tailored as well.

Also, for some applications it may desirable to include a valve (not shown) within the secondary flowpath 28 such that the sensor only periodically receives samples for measurement. This is desirable, for example, where the gas includes large amounts of VOCs or other undesired materials or substances that would rapidly clog the filter if it were exposed, however indirectly, to a constant flow of the gas. Alternatively or additionally, one or more inline filters (not shown) may be used to further protect the sensor 10. Note, however, that the illustrated sensor design, because it avoids exposing the filter 35 and other sensitive components to the direct gas flow, is suitable for use in conditions previously impossible for long-term maintenance-free sensor operation.

Having thus described the preferred embodiment of the invention, what is claimed as new and desired to be protected by Letters Patent includes the following:

1. A system operable to direct a gas flow and to measure the presence of at least one particular gas component thereof, the system comprising:
a flowpath along which the gas flow is directed; and
a gas sensor depending from the flowpath and comprising:
a source operable to produce radiant energy having at least one predetermined characteristic such that the particular gas component will absorb an amount of the radiant energy proportional to the amount of the particular gas component present,
at least one detector operable to detect at least a portion of the unabsorbed radiant energy produced by the source and to generate an output signal having an output signal strength indicative of the strength of the detected radiant energy, with the presence of the particular gas component being indicated by a difference between the output signal strength and a pre-established signal strength reference value; and
a diffuser interposed between the flowpath and the sensor and operable to allow the gas to pass to and from the flowpath by diffusion.

2. The system as set forth in claim 1, further including a closed-ended branch of the flowpath, the gas sensor being located within the branch.

3. The system as set forth in claim 1, the source being a lamp and the radiant energy being infrared radiation.

4. The system as set forth in claim 3, the detector being operable to detect infrared radiation and to generate the output signal having the output signal strength indicative of the strength of the detected infrared radiation.

5. The system as set forth in claim 1, the predetermined characteristic being a particular range of wavelengths.

6. The system as set forth in claim 1, the diffuser comprising a filter.

7. The system as set forth in claim 1, the diffuser comprising a plurality of holes.

8. The system as set forth in claim 1, the gas sensor further comprising a detection chamber within which the source and detector are located, the detection chamber having a surface coated with a material operable to reflect the radiant energy produced by the source.

9. The system as set forth in claim 1, further comprising a filter interposed between the flowpath and the gas sensor and operable to filter the gas sample.

10. A system operable to direct a gas flow and to measure the presence of at least one particular gas component thereof, the system comprising:
a primary flowpath along which the gas flow is directed;
a secondary flowpath coupled to the primary flowpath and operable to divert a portion of the gas flow; and
a gas sensor depending from the secondary flowpath and comprising:
a source operable to produce radiant energy having at least one predetermined characteristic such that the particular gas component will absorb an amount of the radiant energy proportional to the amount of the particular gas component present,
at least one detector operable to detect at least a portion of the unabsorbed radiant energy produced by the source and to generate an output signal having an output signal strength indicative of the strength of the detected radiant energy, with the presence of the particular gas component being indicated by a difference between the output signal strength and a pre-established signal strength reference value, and
a detection chamber within which the source and the detector are located, the detection chamber having a surface coating operable to reflect the radiant energy produced by the source, and
a diffuser interposed between the secondary flowpath and the detection chamber and operable to allow the gas to pass therebetween by diffusion.

11. The system as set forth in claim 10, the system including a gas source coupled with the primary flowpath and operable to produce the gas flow.

12. The system as set forth in claim 11, the gas source being selected from the group consisting of: ovens, combustion chambers, dryers.

13. The system as set forth in claim 10, the primary flowpath being an exhaust flue.

14. The system as set forth in claim 10, the source being a lamp and the radiant energy being infrared radiation.

15. The system as set forth in claim 14, the detector being operable to detect infrared radiation and to generate the output signal having the output signal strength indicative of the strength of the detected infrared radiation.

16. The system as set forth in claim 10, the predetermined characteristic being a particular range of wavelengths.

17. The system as set forth in claim 10, the diffuser comprising a filter.

18. The system as set forth in claim 10, the diffuser comprising a plurality of holes.

19. The system as set forth in claim 1, further comprising a filter interposed between the secondary flowpath and the gas sensor and operable to filter the gas.

20. A gas sensor operable to measure the presence of at least one particular gas component of a gas flow, the gas sensor comprising:
a housing defining a reception chamber and a detection chamber;
the reception chamber having at least one inlet for allowing the gas sample to enter the reception chamber and at least one outlet for allowing the gas sample to exit the reception chamber, and
the detection chamber being exposed to the reception chamber;
a sensing element located in the detection chamber and comprising
a source operable to produce radiant energy having at least one predetermined characteristic such that the particular gas component will absorb an amount of the radiant energy proportional to the amount of the particular gas component present, and
at least one detector operable to detect at least a portion of the unabsorbed radiant energy produced by the source and to generate an output signal having an output signal strength indicative of the strength of the detected radiant energy, with the presence of the particular gas component being indicated by a difference between the output signal strength and a pre-established signal strength reference value;
a diffuser interposed between the reception and detection chambers and operable to allow the gas to pass therebetween by diffusion; and
a filter interposed between the reception and detection chambers and operable to filter the gas entering the detection chamber.

21. The gas sensor as set forth in claim 20, the source being a lamp and the radiant energy being infrared radiation.

22. The gas sensor as set forth in claim 21, the detector being operable to detect infrared radiation and to generate the output signal having the output signal strength indicative of the strength of the detected infrared radiation.

23. The gas sensor as set forth in claim 20, the surface of the detection chamber being coated with a reflective material operable to reflect the radiant energy produced by the source.

24. The gas sensor as set forth in claim 20, the diffuser comprising a filter.

25. The gas sensor as set forth in claim 20, the diffuser comprising a plurality of holes.

27. A method of measuring the presence of a particular gas component in a gas flow, the method comprising the steps of:
(a) establishing a secondary flowpath for diverting a gas sample from the primary flowpath;
(b) receiving the gas sample from the secondary flowpath;
(c) diffusing the gas sample through a diffusion mechanism;
(d) exposing the gas sample to radiant energy produced by a source, the radiant energy having at least one predetermined characteristic such that the particular gas component will absorb an amount of the radiant energy proportional to the amount of the gas present;
(e) detecting the amount of radiant energy not absorbed by the particular gas component;
(f) generating an output signal having an output signal strength indicative of the amount of radiant energy detected; and
(g) determining the presence of the particular gas component present in the gas sample based upon a difference between the output signal strength and a pre-established signal strength reference value.

28. The method as set forth in claim 27, further including the step of (h) filtering the gas sample prior to performing step (d).

29. The method as set forth in claim 28, step (h) including the step of filtering smoke, oil, dust, and water vapor from the gas sample.
